(19) United States
(12) Patent Application Publication
(10) Pub. No.: US 2010/0322455 A1
(43) Pub. Date: Dec. 23, 2010

(54) WIRELESS LOUDSPEAKER

(75) Inventor: Jason L. Carlson, Sudbury, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: EMO LABS, INC., Waltham, MA (US)

(21) Appl. No.: 12/744,074

(22) PCT Filed: Nov. 21, 2008
(86) PCT No.: PCT/US08/84359

§ 371 Date: Sep. 13, 2010

Related U.S. Application Data
(60) Provisional application No. 60/989,687, filed on Nov. 21, 2007.
(60) Provisional application No. 60/989,700, filed on Nov. 21, 2007.

(51) Int. Cl. H04R 1/02

(52) U.S. Cl. 381/387; 381/386; 381/394

(57) ABSTRACT

A wireless speaker may include a housing comprising a networking module configured to receive a signal from an audio source, a power amplifier configured to amplify the signal, and at least one speaker configured to translate the electrical signal into an acoustic wave. The wireless speaker may also include at least one electrical connector configured to be electrically and mechanically coupled to a power source, such as an AC outlet. The electrical connector may be configured to orientate the wireless speaker in various positions relative to wall and may be configured to allow the wireless speaker to pivot or rotate relative to the wall. The wireless speaker may also include at least one light source configured to illuminate at least a portion of the speaker membrane.

### CROSS REFERENCE TO RELATED APPLICATIONS

This application claims priority to U.S. Provisional Application Ser. Nos. 60/989,687 and 60/989,700, filed Nov. 21, 2007, both which are fully incorporated herein by reference.

### FIELD

The present disclosure relates to loud speakers, and more particularly pertains to wireless speakers.

### BACKGROUND

Wireless speaker systems that transmit and receive musical signals over a wireless link are known. Such system may include a music source including a transmitter that transmits a musical signal using a wireless link to a wireless loudspeaker. The wireless loudspeaker may include a receiver configured to receive the music signal and an amplifier to amplify the musical signal and power the wireless louder drivers. The wireless loudspeaker may include a power cord configured to be coupled to a power source (such as a power outlet) to provide power to the wireless loudspeaker. However, the power cord may be undesirable from an aesthetic perspective and/or may increase the risk of injury due to accidental tripping.

### SUMMARY

The present disclosure related in one embodiment to an apparatus including a housing defining an enclosure. A receiver may be coupled to the housing and may be configured to receive a wireless signal representative of an audio signal. An amplifier may be coupled to the housing and may be configured to amplify the audio signal. At least one electromechanical transducer may be coupled to the housing and the amplifier and configured to generate sound waves. At least one electrical connector may be configured to electrically couple the apparatus to an electrical source to provide electric power to the receiver and the amplifier. The electrical connector may be further configured to mechanically couple and mount the apparatus to the electrical source. As such, the apparatus may eliminate the need for a flexible power cord.

The present disclosure relates in another embodiment to a system including a transmitter and a wireless loudspeaker. The receiver may be configured to send a wireless signal representative of an audio signal from an audio source. The wireless loudspeaker may include a housing defining an enclosure and a receiver coupled to the housing. The receiver may be configured to receive the wireless signal representative of the audio signal which may be amplified by an amplifier coupled to the housing. At least one electromechanical transducer may be coupled to the housing and the amplifier and may be configured to generate sound waves based on the audio signal. At least one electrical connector may be configured to electrically couple the wireless loudspeaker to an electrical source to provide electric power to the receiver and the amplifier. The electrical connector may be further configured to mechanically couple and mount the wireless loudspeaker to the electrical source.

In yet another embodiment, the present disclosure may relate to a method comprising receiving, at a receiver of a wireless loudspeaker, a wireless signal representative of an audio signal from an audio source. The method may also comprise electrically and mechanically coupling the wireless loudspeaker to an electrical source using at least one electrical connector coupled to a housing of the wireless loudspeaker. The electrical connector may be configured to provide electric power to the receiver and the amplifier and to mount the loudspeaker to the electrical source. The method may further comprise generating sound waves using at least one electromechanical transducer coupled to the housing and the amplifier based on the audio signal.

### BRIEF DESCRIPTION OF THE DRAWINGS

Features and advantage of the present disclosure will be apparent from the following description of embodiments consistent therewith, which description should be considered in conjunction with the accompanying drawings, wherein:

FIG. 1 is a cross-sectional view of one embodiment of a wireless speaker consistent with the present disclosure;

FIG. 2 is a front plan view of one embodiment of the wireless speaker shown in FIG. 1;

FIG. 3 is a rear plan view of one embodiment of the wireless speaker shown in FIG. 1;

FIG. 4 is a cross-sectional view of one embodiment of the wireless speaker coupled to a power source;

FIG. 5 is a cross-sectional view of another embodiment of a wireless speaker having a removable electrical connector;

FIGS. 6-11 are front and side views of various configurations of removable electrical connectors;

FIG. 12 is a cross-sectional view of one embodiment of a wireless speaker having housing pivotally or rotatably coupled to a base region and a support surface;

FIG. 13 is a cross-sectional view of one embodiment of a wireless speaker light consistent with the present disclosure;

FIG. 14 is a top plan view of one embodiment of the wireless speaker light shown in FIG. 13;

FIG. 15 is a top plan view of another embodiment of the wireless speaker light shown in FIG. 13;

FIG. 16 is a side plan view of one embodiment of the wireless speaker light shown in FIG. 13;

FIG. 17 is a cross-sectional view of one embodiment of the wireless speaker light coupled to a power source; and

FIG. 18 are cross-sectional views of one embodiment of a wireless speaker light having base region and speaker pivotally or rotatably coupled to a housing and a support surface.

### DESCRIPTION

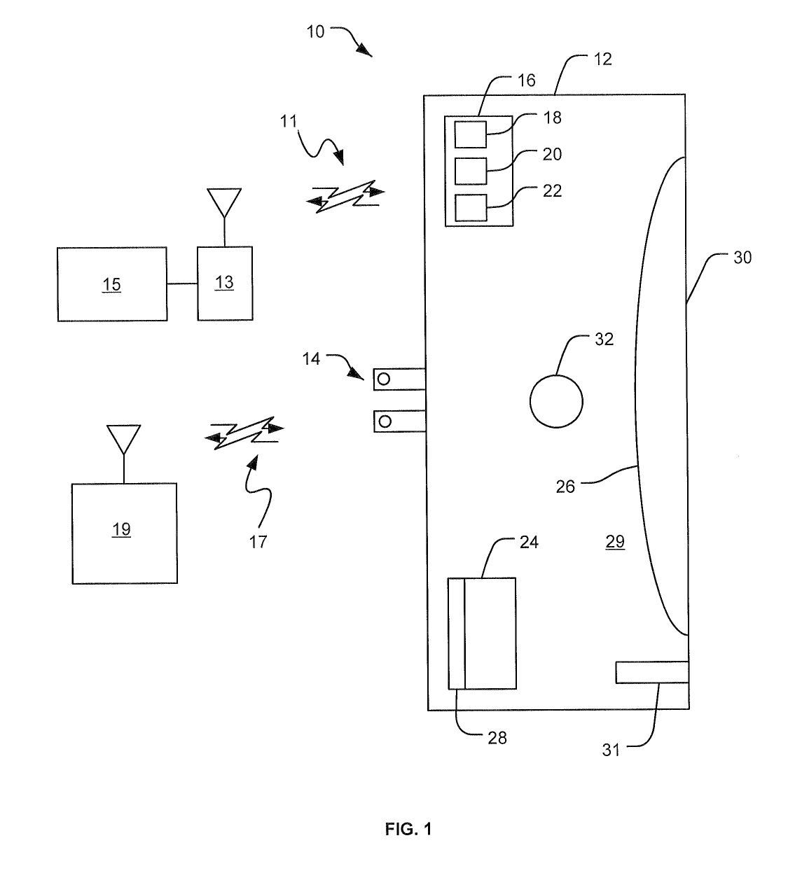

Referring to FIG. 1, a cross-sectional view of one embodiment of a wireless loudspeaker 10 is shown. The wireless loudspeaker 10 may comprise a housing 12 including at least one electrical connector or plug 14 configured to be coupled to an electrical source (such as, but not limited to, a/c current from a standard outlet, direct current from batteries or, for example, a A/C-D/C or D/C-C/C converter or the like) and to provide power to the wireless loudspeaker 10. The housing 12 may also include at least one networking module 16 coupled to the electrical connector 14 and configured to receive at least one signal 11 from a transmitter 13 coupled to an audio source 15 representing an audio signal.

The networking module 16 may include a receiver 18 for receiving the signal 11 from the transmitter 13, at least one processor 20 for processing the signal 11 and optionally a transmitter 22. The receiver 18 may be configured to receive any analog or digital wireless signal 11 such as, but not limited to, a signal transmitted over prescribed electromagnetic bands, for example in the 900 MHz range, 2.4 to 2.483 GHz, and/or 5.725 to 5.875 GHz, Bluetooth, infrared, or the like. The receiver 18 may also be configured to receive one or more command signals 17 from a remote controller 19. For example, the command signals 17 may be configured to control one or more functions of the wireless loudspeaker 10 such as, but not limited to, a power on command, power off command, volume command, source command, zone command, and/or adjust one or more properties of the audio such as treble and/or bass control. The processor 20 may include digital and/or analog audio circuitry configured to convert and/or demodulate the signal received from the audio source from a particular signal format (either analog or digital) for amplification. For example, the processor 20 may include an A/D and/or a D/A converter, filter, and the like. The transmitter 22 may optionally rebroadcast one or more signals representing audio signals and/or may transmit a signal back to the transmitter 13 and audio source 15.

At least one power amplifier 24 may be coupled to both the electrical connector 14 and the networking module 16. The power amplifier 24 may be configured to amplify the signal from the networking module 16 to properly drive one or more speakers 26. The power amplifier 24 may be at least partially disposed within and/or coupled to the housing 12 and may optionally include one or more heat sinks or cooling fins 28 configured to dissipate heat generated by the power amplifier 24. The power amplifier 24 may optionally include automatic power circuitry configured to automatically turn the wireless loudspeaker 10 on upon receiving a signal 11 from the transmitter 13 and audio source 15 and may also be configured to automatically turn the wireless loudspeaker 10 off after a predetermined amount of inactivity. While the processor 20 has been described as being part of the networking module 16, the networking module 16 may receive a signal 11 from the transmitter 13 and audio source 15 and transmit the signal to the power amplifier 24 which may then process and amplify the signal.

One or more speakers 26 may be coupled to the housing 12 and may include any electromechanical transducer configured to convert the electrical signal from the power amplifier 24 into sound. For example, one or more of the speakers 26 may include a horn driver, piezoelectric driver, electrostatic driver, ribbon and/or planar magnetic drivers, flat panel driver, heil air motion transducers and the like. According to one embodiment, one or more of the speakers 26 may include an acoustical transducer and overall system as described in U.S. Pat. Nos. 6,720,708 and 7,038,356, both of which are fully incorporated herein by reference. Accordingly, one may employ herein a diaphragm that is curved, at least one support on at least a portion of such diaphragm, and at least one activator operatively coupled to the diaphragm and spaced from the support, where the actuator is configured such that movement of the actuator produced corresponding movement of the diaphragm and the diaphragm movement is amplified with respect to the actuator movement.

The wireless loudspeaker 26 may be coupled to the housing 12 such that the housing 12 forms at least part of an enclosure 29 for the speaker 26. The enclosure 29 may be substantially hermetically sealed to the speaker 26 and/or may include one or more tuned ports 31. At least part of the speaker (for example, the diaphragm or speaker membrane) may include carbon fiber and/or glass fiber. Optionally, the wireless loudspeaker 10 may include one or more light sources 32 (such as, but not limited to, LEDs, incandescent light bulbs, compact fluorescent lights, or the like) configured to at least partially illuminate part of the speaker 26. According to one embodiment, the speaker 26 may include a diaphragm including a translucent or transparent material such as, but not limited to, film material or glass fibers (e.g., glass fibers made by Owens Corning). In this manner, the wireless loudspeaker 10 may function as a light and/or as a light diffuser. Additionally, the wireless loudspeaker 10 may include a plurality of light sources 32 configured to produce light of various colors. The plurality of light sources 32 may be configured to produce light patterns in response to the audio signal and function as a “light show.”

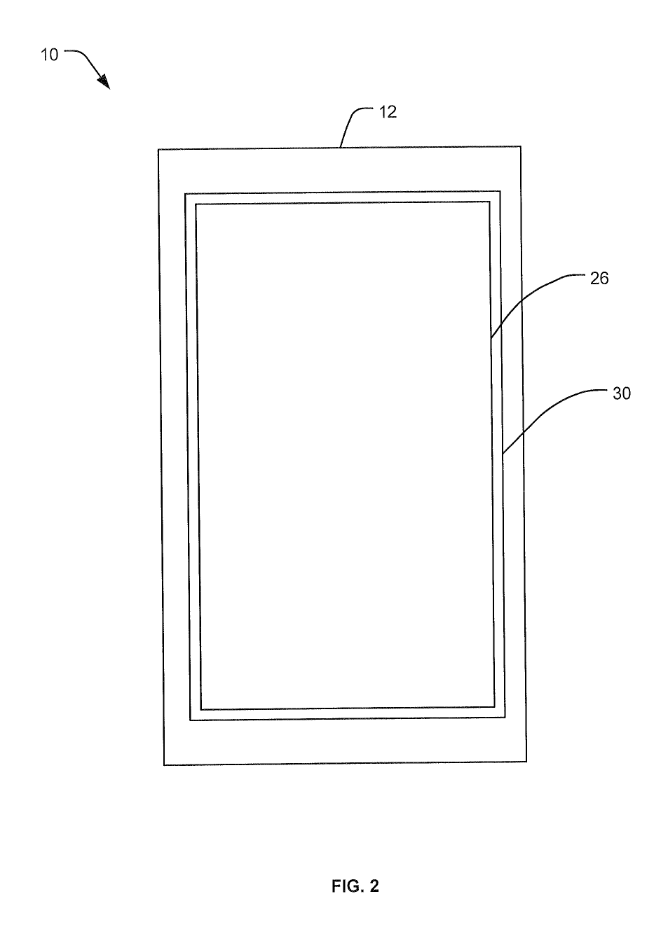

Turning now to FIG. 2, a front plan view of one embodiment of the wireless loudspeaker 10 is shown. The wireless loudspeaker 10 may optionally include a grill, cover, or the like configured to be at least partially disposed over an external surface of the speaker 26. The grill or cover 30 may be generally acoustically transparent and may increase the aesthetic appearance of the wireless loudspeaker 10 and/or protection of the wireless loudspeaker 10 (and specifically the speaker 26). The grill 30 may also be substantially translucent or transparent, for example, to allow light emitted from the light source 32 to pass. Additionally, the grill 30 may function as a light diffuser.

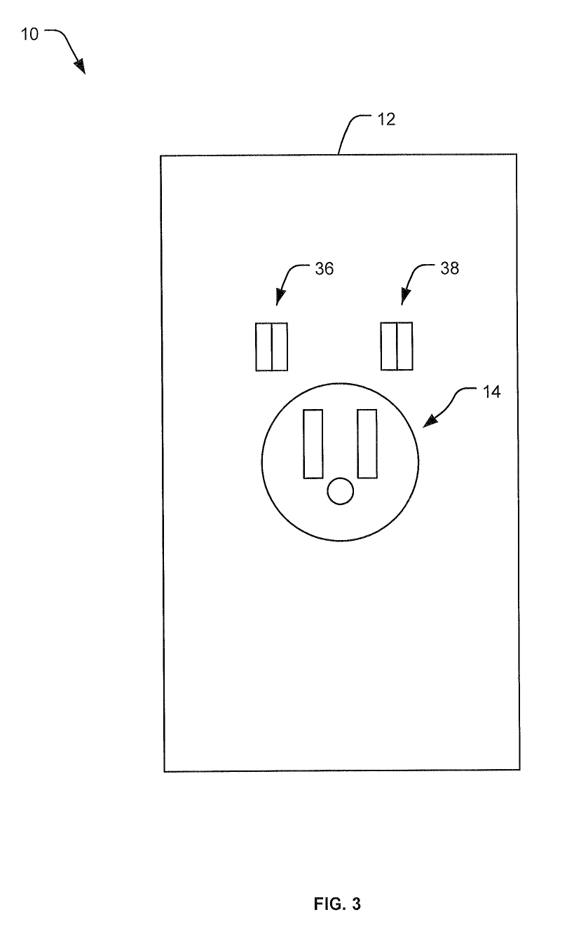

Referring to FIG. 3, a plan view of one embodiment of the rear or back of the wireless loudspeaker 10 is shown. As shown, the rear of the wireless speaker 10 may be configured to include the electrical connector 14 discussed above. One or more switches, buttons, or the like 36 may be disposed about the rear of the wireless loudspeaker 10 and configured to allow the user to select one or more zones and/or channels. The rear of the wireless loudspeaker 10 may optionally include one or more switches, buttons, or the like 38 configured to allow the user to set the placement of the wireless loudspeaker 10 within the room/area. For example, the switches 38 may allow the user to configure the placement of the wireless loudspeaker 10 within a room for stereo and/or home theater applications. For instance, the switches 38 may allow the user to define a wireless loudspeaker 10 as a front left channel, front right channel, center channel, rear left channel, and/or rear right channel within a home theater application. Since the switches 36, 38 may disposed on the rear of the wireless loudspeaker 10, the switches 36, 38 may only be accessible to the user when the wireless loudspeaker 10 is unplugged and powered down. As a result, networking and control commands for switching the wireless loudspeaker 10 from one state to another may be simplified and the risk of accidental damage to the wireless loudspeaker 10 may be reduced.

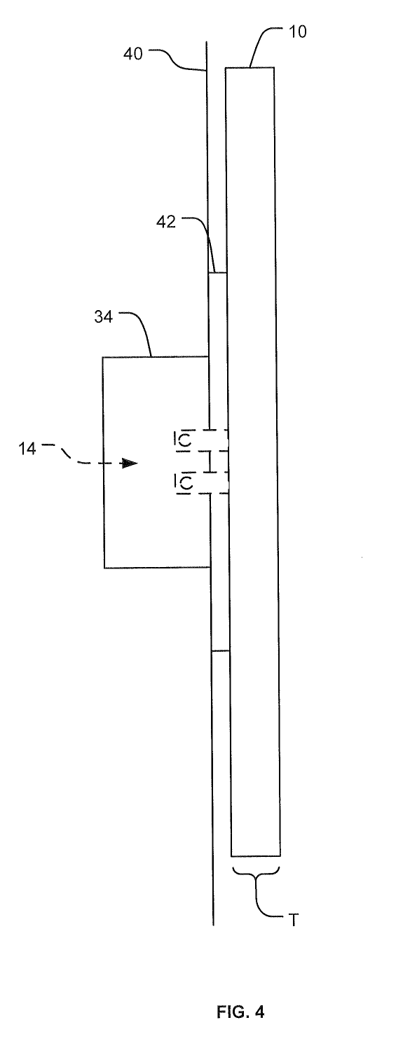

According to one embodiment, the wireless loudspeaker 10, FIG. 4, may configured to be plugged directly into an electrical outlet 34, such as an A/C electrical outlet. As a result, the wireless loudspeaker 10 may eliminate the need for a separate power cord and may therefore reduce the likelihood of accidental injury associated with a power cord as discussed above. Additionally, the wireless loudspeaker 10 may be configured to be substantially adjacent to a support surface 40 such as a wall, ceiling, or the like. For example, the wireless loudspeaker 10 may substantially abut against the cover 42 of the electrical outlet 34 or may substantially abut against the support surface 40 when coupled to a flush-mounted outlet 34. As a result, the wireless loudspeaker 10 may take up relatively minimal space within a room or area and therefore may be more aesthetically pleasing. The cross-sectional thickness T and/or weight of the wireless loudspeaker 10 may also be minimized by utilizing a thin speaker 26 such as a piezoelectric driver, electrostatic driver, ribbon and/or planar magnetic drivers, flat panel driver, heil air motion transducers, and the acoustic transducers described in U.S. Pat. Nos. 6,720,708 and 7,038,356. For example, it may have an overall thickness of 1.0 inches an overall width of 4.0 inches and an overall length of 8.0 inches.

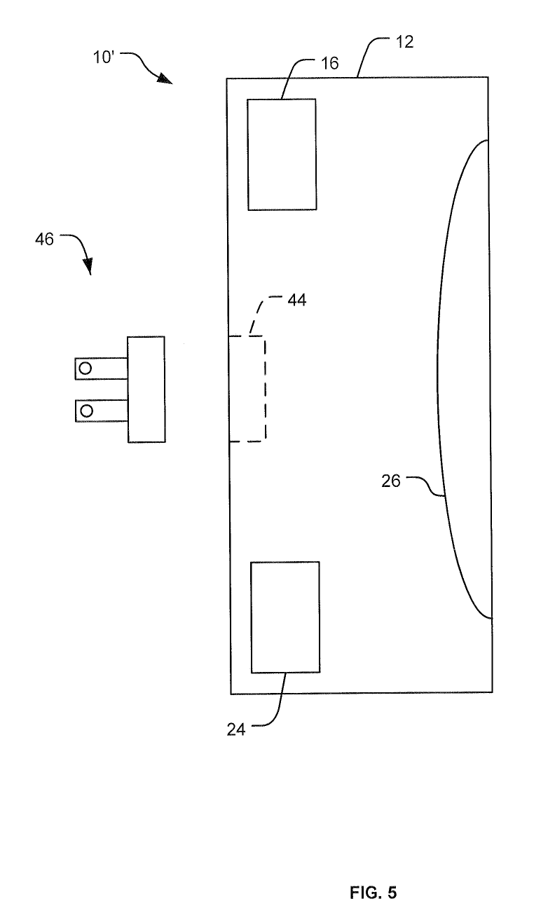

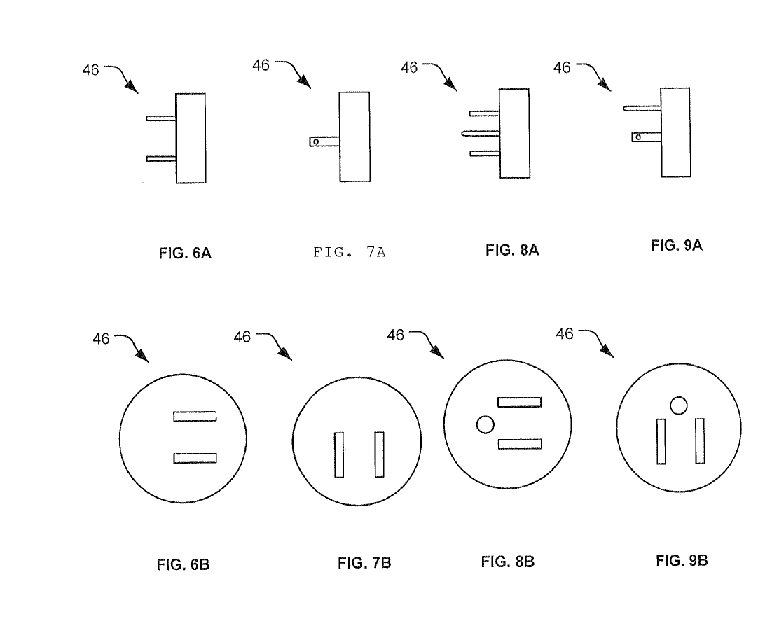

As mentioned above, the wireless loudspeaker 10 may include one or more electrical connectors 14. For example, the electrical connectors 14 may be formed as an integral or unitary component of the housing 12 as generally shown in FIG. 1. Turning now to FIG. 5, a cross-sectional view of another embodiment of the wireless loudspeaker 10′ is shown in which the housing 12 may include one or more cavities or protrusions 44 configured to be coupled to one or more removable electrical connectors 46. Referring to FIGS. 6A-11B, several removable electrical connectors 46 are shown in front and side view that may be configured to be electrically and mechanically coupled to various power sources. For example, the removable electrical connectors 46, FIGS. 6A-7B may include a first and a second pin configured to be mechanically and electrically coupled to two or three slot/hole AC outlets. The removable electrical connectors 46 of FIGS. 8A-9B may also include three pins configured to be coupled three slot/hole AC outlets (for example, three-slot outlets having a positive, negative and a ground).

The removable electrical connectors 46 may be rotatably received in the cavity/protrusion 44 such that the wireless loudspeaker 10 may be rotated in a plane substantially parallel to at least a portion of the support surface 40. The removable electrical connectors 46 and/or the cavity 44 may include slip ring or the like configured to maintain electrical continuity between the removable electrical connectors 46 and the cavity 44.

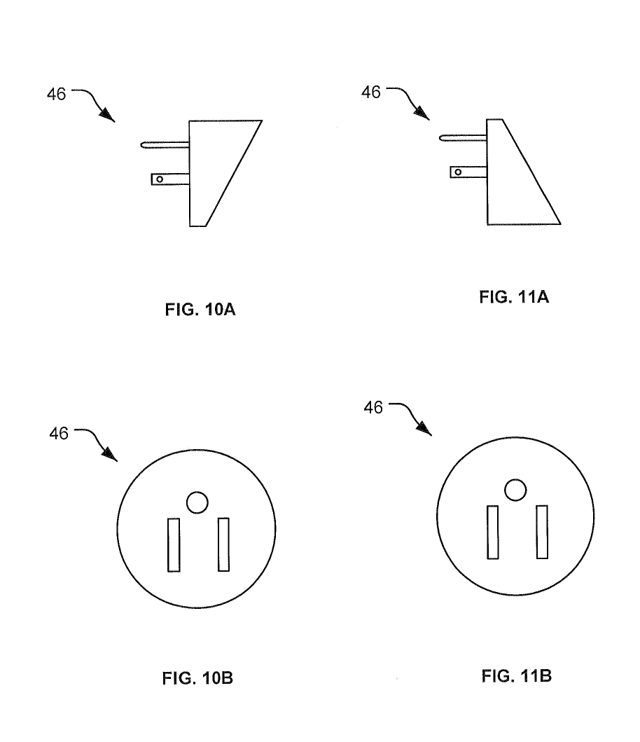

According to another embodiment, the removable electrical connectors 46 may be received in the cavity/protrusion 44 in a predetermined orientation with respect to the housing 12. For example, the removable electrical connectors 46, FIGS. 6A, 6B, 8A, 8B may be configured to be received in the cavity/protrusion 44 of the housing 12 such that the wireless loudspeaker 10 is orientated in a landscape configuration and substantially planar with at least a portion of the support surface 40. According to another embodiment, the removable electrical connectors 46, FIGS. 7A, 7B, 9A, 9B may be configured to be received in the cavity/protrusion 44 of the housing 12 such that the wireless loudspeaker 10 is orientated in a portrait configuration substantially planar with at least a portion of the support surface 40. In yet another embodiment, the removable electrical connectors 46, FIGS. 10A, 10B, 11A, 11B may be configured to be received in the cavity/protrusion 44 of the housing 12 such that the wireless loudspeaker 10 is orientated at an angle greater than or less than 180 degrees with respect to at least a portion of the support surface 40.

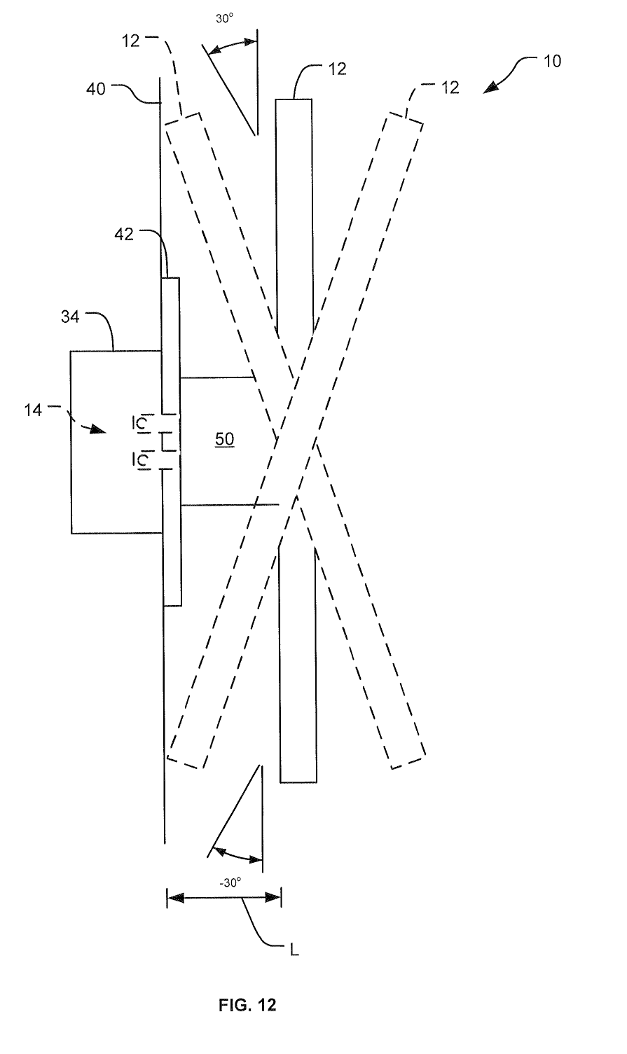

Turning now to FIG. 12, one embodiment of a wireless loudspeaker 10 is shown which may be pivotable or rotatable with respect to the support surface 40. The wireless loudspeaker 10 may include a base region 50 including one or more electrical connectors 14 configured to be electrically and mechanically coupled to power outlet 34. The base region 50 may space the housing 12 of the wireless loudspeaker 10 away from the support surface 40 when in planar orientation with respect to the support surface 40 such that the housing 12 (and the speaker 26) may pivot or rotate relative to the base portion 50 and/or the support surface 40. The distance L in which the housing 12 is spaced from the support surface 40 and/or the outlet cover 42 may depend on the overall dimensions of the wireless loudspeaker 10 as well as the desired amount of pivoting or rotation. According to one embodiment, the housing 12 may be pivoted +/−30 degrees relative to the plane defined by the support surface 40. It should be noted that the networking module 16 and/or the power amplifier 24 may be at least partially disposed within the base region 50, thereby further reducing the cross-sectional thickness T of the housing 12. Additionally, the base portion 50 may be formed as an integral, unitary component of the housing 12 or may be removeably coupled to the housing 12.

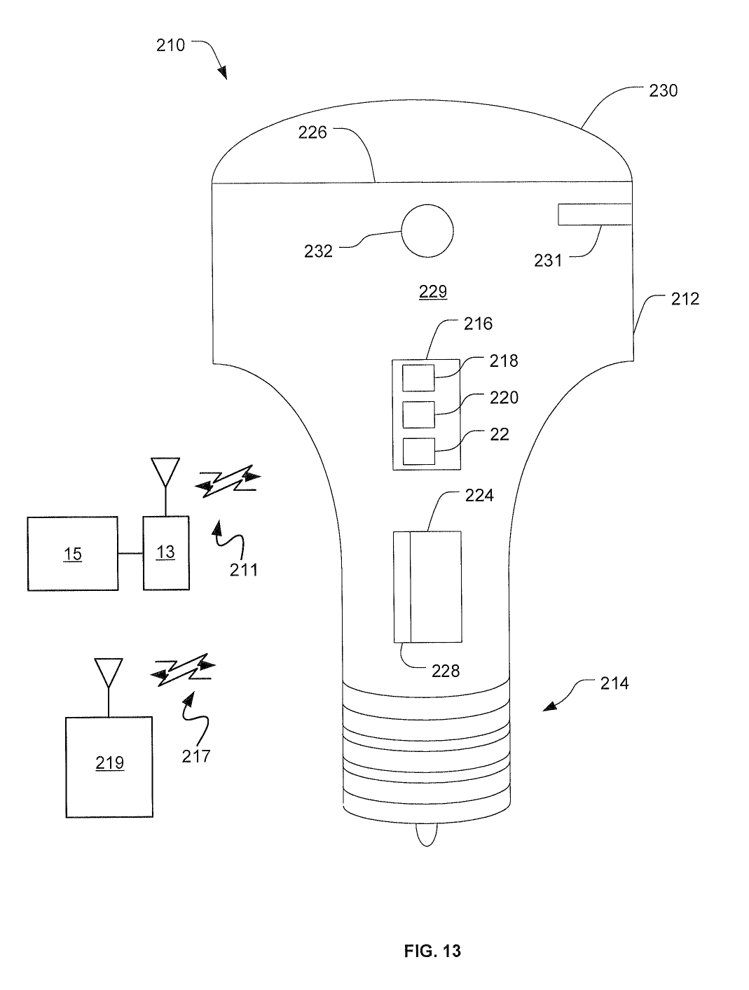

Referring now to FIG. 13, a cross-sectional view of yet another embodiment of a wireless loudspeaker light 210 is shown. The wireless loudspeaker light 210 may comprise a housing 212 including at least one electrical connector or plug 214 configured to be coupled to an electrical source (such as, but not limited to, a/c or d/c current from a standard light outlet or the like) and to provide power to the wireless loudspeaker light 210. The housing 212 may also include at least one networking module 216 coupled to the electrical connector 214 and configured to receive at least one signal 211 from a transmitter 213 coupled to an audio source 215 representing an audio signal.

The networking module 216 may include a receiver 218 for receiving the signal 211 from the transmitter 213, at least one processor 220 for processing the signal 211 and optionally a transmitter 222. The receiver 218 may be configured to receive any analog or digital wireless signal 211 such as, but not limited to, a signal transmitted over prescribed electromagnetic bands, for example in the 900 MHz range, 2.4 to 2.483 GHz, and/or 5.725 to 5.875 GHz, Bluetooth, infrared, or the like. The receiver 218 may also be configured to receive one or more command signals 217 from a remote controller 219. For example, the command signals 217 may be configured to control one or more functions of the wireless loudspeaker light 210 such as, but not limited to, a power on command, power off command, volume command, source command, zone command, and/or adjust one or more properties of the audio such as treble and/or bass control. The processor 220 may include digital and/or analog audio circuitry configured to convert and/or demodulate the signal 211 transmitted by the transmitter 213 coupled to the audio source 215 from a particular signal format (either analog or digital) for amplification. For example, the processor 220 may include an A/D and/or a D/A converter, filter, and the like. The transmitter 222 may optionally rebroadcast one or more signals representing audio signals and/or may transmit a signal back to the transmitter 213 and/or audio source 215.

At least one power amplifier 224 may be coupled to both the electrical connector 214 and the networking module 216. The power amplifier 224 may be configured to amplify the signal from the networking module 216 to properly drive one or more speakers 226. The power amplifier 224 may be at least partially disposed within and/or coupled to the housing 212 and may optionally include one or more heat sinks or cooling fins 228 configured to dissipate heat generated by the power amplifier 224. The power amplifier 224 may optionally include automatic power circuitry configured to automatically turn the wireless loudspeaker light 210 on upon receiving an appropriate signal from the audio source and may also be configured to automatically turn the wireless loudspeaker light 210 off after a predetermined amount of inactivity. While the processor 220 has been described as being part of the networking module 216, the networking module 216 may receive a signal 211 from the audio source 215 and transmit the signal to the power amplifier 224 which may then process and amplify the signal.

One or more speakers 226 may be coupled to the housing 212 and may include any electromechanical transducer configured to convert the electrical signal from the power amplifier 224 into sound. For example, one or more of the speakers 226 may include a horn driver, piezoelectric driver, electrostatic driver, ribbon and/or planar magnetic drivers, flat panel driver, heil air motion transducers and the like. According to one embodiment, one or more of the speakers 26 may include an acoustical transducer as described in U.S. Pat. Nos. 6,720,708 and 7,038,356, both of which are fully incorporated herein by reference. Accordingly, one may employ herein a diaphragm that is curved, at least one support on at least a portion of such diaphragm, and at least one activator operatively coupled to the diaphragm and spaced from the support, where the actuator is configured such that movement of the actuator produced corresponding movement of the diaphragm and the diaphragm movement is amplified with respect to the actuator movement.

The speaker 226 may be coupled to the housing 212 such that the housing 212 forms at least part of an enclosure 229 for the speaker 226. The enclosure 229 may be substantially hermetically sealed to the speaker 226 and/or may include one or more tuned ports 231. At least part of the speaker (for example, the diaphragm or speaker membrane) may include carbon fiber and/or glass fiber. Optionally, the wireless loudspeaker light 210 may include one or more light sources 232 (such as, but not limited to, LEDs, incandescent light bulbs, compact fluorescent lights, or the like) configured to at least partially illuminate part of the speaker 226. The light source 232 may be either replaceable or non-replaceable.

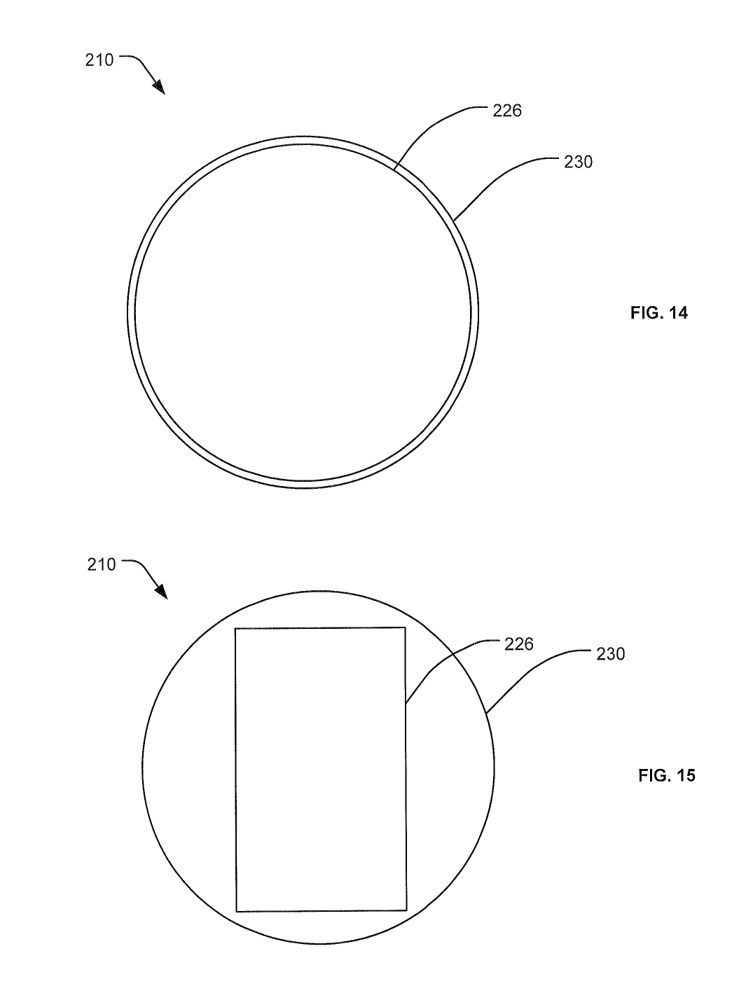

Turning now to FIG. 14, a top plan view of one embodiment of the wireless loudspeaker light 210 is shown wherein the speaker 2226 may include a diaphragm including a translucent or transparent material such as, but not limited to, film material or glass fibers (e.g., glass fibers made by Owens Corning). The speaker 226 may be configured such that at least a portion of the light generated by the light source 232 to passes through speaker 226. In this manner, the wireless loudspeaker light 210 may function as a light. Additionally, the speaker 226 may function as a light diffuser. Alternatively (or in addition), at least a portion of the housing 212, FIG. 15, (for example, the top or distal end of the housing 212 generally opposite the electrical connector 214) may be a translucent or transparent material such that at least a portion of the light generated by the light source 232 is allowed to pass through the housing 212. The wireless loudspeaker light 210 may optionally include a plurality of light sources 232 configured to produce light of various colors. The plurality of light sources 232 may be configured to produce light patterns in response to the audio signal and function as a “light show.”

The wireless loudspeaker light 210 may optionally include a grill, cover, or the like configured to be at least partially disposed over an external surface of the speaker 226. The grill or cover 230 may be generally acoustically transparent may increase the aesthetic appearance of the loudspeaker 210 and/or protection of the loudspeaker 210 (and specifically the speaker 226). The grill 230 may also be substantially translucent or transparent, for example, to allow light emitted from the light source 232 to pass. Additionally, the grill 230 may function as a light diffuser.

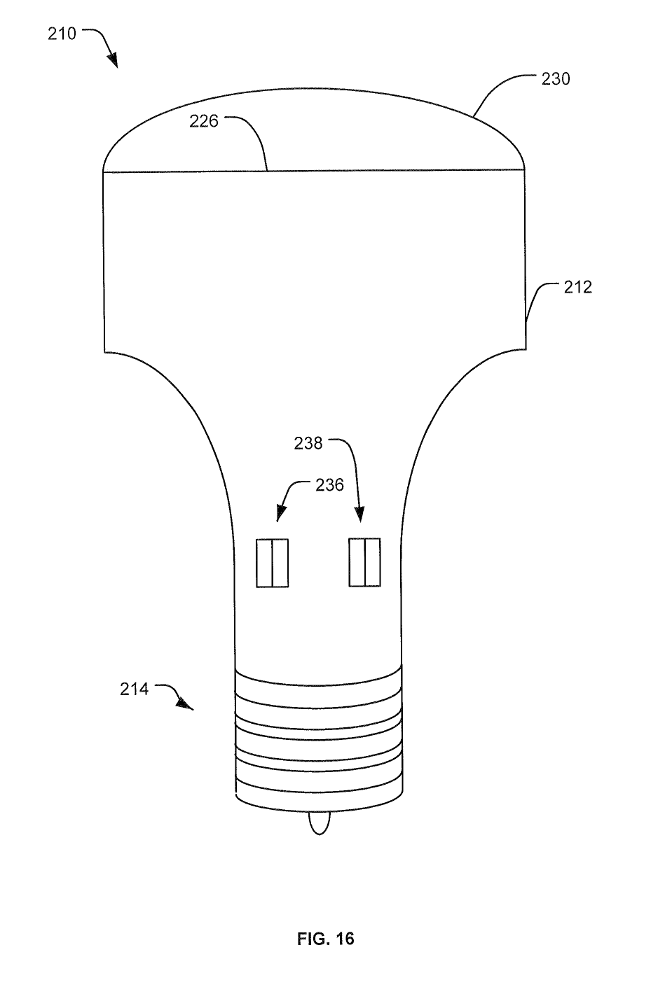

Referring now to FIG. 16, a plan side view of one embodiment of the wireless loudspeaker light 210 is shown. The wireless loudspeaker speaker light 210 may include one or more switches, buttons, or the like 236 configured to allow the user to select one or more zones and/or channels. The wireless loudspeaker light 210 may also include one or more switches, buttons, or the like 238 configured to allow the user to set the placement of the wireless loudspeaker light 210 within the room/area. For example, the switches 238 may allow the user to configure the placement of the wireless loudspeaker light 210 within a room for stereo and/or home theater applications. According to one embodiment, the switches 238 may allow the user to define a wireless loudspeaker light 210 as a front left channel, front right channel, center channel, rear left channel, and/or rear right channel within a home theater application. Since the switches 236, 238 may disposed on the rear of the wireless loudspeaker light 210, the switches 236, 238 may only be accessible to the user when the wireless loudspeaker light 210 is unplugged and powered down. As a result, networking and control commands when switching the wireless loudspeaker light 210 from one state to another may be simplified and the risk of accidental damage to the wireless speaker 210 may be reduced.

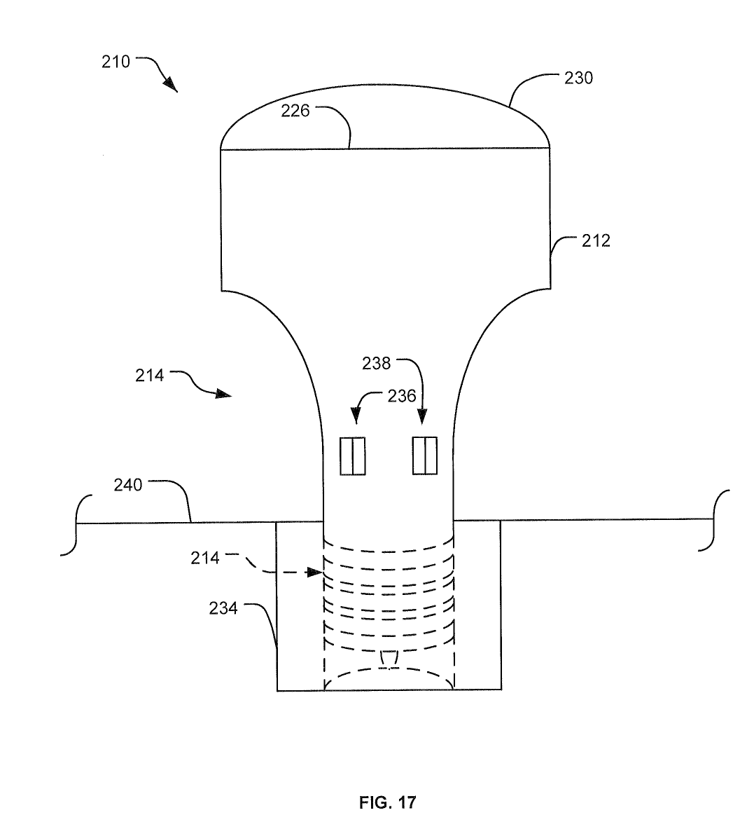

According to one embodiment, the wireless loudspeaker light 210, FIG. 17, may be configured to be plugged directly into an electrical light outlet 234, such as an A/C electrical outlet. As a result, the wireless loudspeaker light 210 may eliminate the need for a separate power cord and may therefore reduce the likelihood of accidental injury associated with a power cord as discussed above. Additionally, since the wireless loudspeaker light 210 may be coupled to a light outlet 234, the wireless loudspeaker light 210 may take up minimal space within a room or area and may be more aesthetically pleasing.

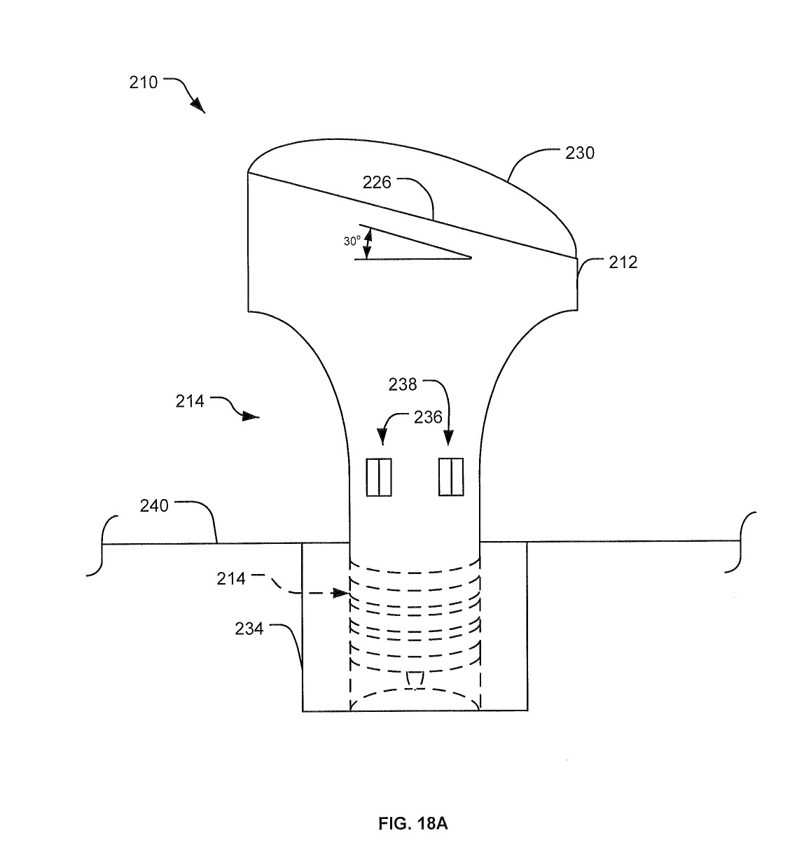

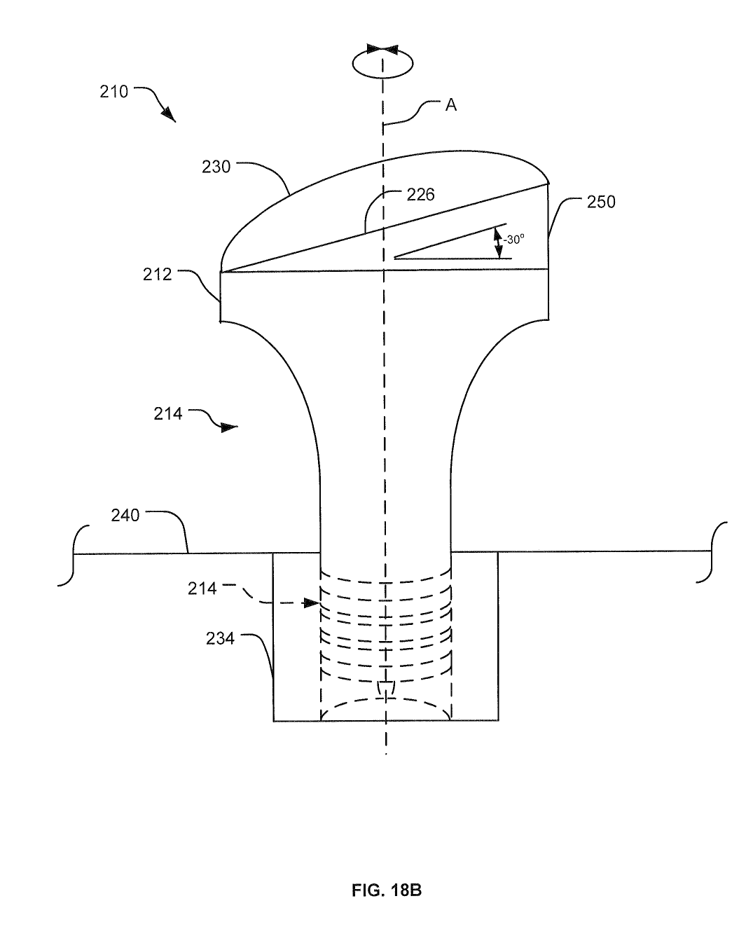

Turning now to FIG. 18, one embodiment of a wireless loudspeaker light 210 is shown which may be pivotable and/or rotatable with respect to the support surface 240. The wireless loudspeaker light 210 may include a base region 250 pivotally and/or rotatably coupled to the housing 212. According to one embodiment, the base region 250 may be pivoted +/−30 degrees relative to the plane defined by the support surface 240, outlet 234, and/or the housing 212. Alternatively (or in addition), the base region may rotate up to 360 degrees around the longitudinal axis A of the housing 212 and/or outlet 234. The base region 250 may include a slip ring connection or the like between the power amplifier 24 and the speaker 226 to provide electrical continuity while the speaker 226 rotates. The pivoting and/or rotation of the speaker 226 may facilitate the precise placement/aiming of the wireless loudspeaker light 210 relative to the listening area.

The present disclosure is not intended to be limited to an apparatus, system or method which must satisfy one or more of any stated or implied object or feature of the present disclosure and should not be limited to the preferred, exemplary, or primary embodiment(s) described herein. The foregoing description of a preferred embodiment of the present disclosure has been presented for purposes of illustration and description. It is not intended to be exhaustive or to limit the present disclosure to the precise form disclosed. Obvious modifications or variations are possible in light of the above teachings. The embodiment was chosen and described to provide the best illustration of the principles of the present disclosure and its practical application to thereby enable one of ordinary skill in the art to utilize the present disclosure in various embodiments and with various modifications as is suited to the particular use contemplated. All such modifications and variations are within the scope of the present disclosure when interpreted in accordance with breadth to which it is fairly, legally and equitably entitled.

What is claimed is:

1. An apparatus comprising:
a housing defining an enclosure;
a receiver coupled to said housing, said receiver configured to receive a wireless signal representative of an audio signal;
an amplifier coupled to said housing and configured to amplify said audio signal;
at least one electromechanical transducer coupled to said housing and said amplifier and configured to generate sound waves; and
at least one electrical connector configured to electrically couple said apparatus to an electrical source to provide electric power to said receiver and said amplifier, said at least one electrical connector further configured to mechanically couple and mount said apparatus to said electrical source.

2. The apparatus of claim 1, further comprising at least one light source configured to at least partially illuminate a portion of said at least one electromechanical transducer.

3. The apparatus of claim 1, wherein said at least one light source is disposed within said enclosure.

4. The apparatus of claim 3, wherein said at least one electromechanical transducer comprises an at least partially translucent material configured to allow at least a portion of said light generated by said at least one light source to be emitted through said at least one electromechanical transducer.

5. The apparatus of claim 4, wherein said at least one electromechanical transducer comprises a light diffuser.

6. The apparatus of claim 1, wherein said housing further comprises a transmitter configured to send a wireless signal representing at least one an audio signal.

7. The apparatus of claim 1, wherein said receiver is configured to receive a wireless command signal operative to control at least one function of said apparatus.

8. The apparatus of claim 1, wherein said at least one electrical connector comprises a removable connector configured to be removably coupled to said housing.

9. The apparatus of claim 8, wherein removable connector is configured to be at least partially received within a cavity of said housing.

10. The apparatus of claim 8, wherein said removable connector is configured to be rotatably coupled to said housing.

11. The apparatus of claim 8, wherein said removable connector is configured to be pivotally coupled to said housing.

12. The apparatus of claim 1, further comprising a base region including said at least one electrical connector, said base region configured to be coupled to said housing and to provide a spacing between said housing and a support surface coupled to said power source.

13. The apparatus of claim 12, wherein said housing is configured to be pivotally coupled to said base region.

14. The apparatus of claim 13, wherein said housing is configured to be pivoted +/−30 degrees relative to a plane defined by said support surface.

15. The apparatus of claim 1, wherein said at least one electrical connector is configured to be coupled to a light socket.

16. The apparatus of claim 1, wherein said at least one electrical connector comprises a first and a least a second electrical terminal configured to be coupled to an electrical outlet.

17. A system comprising:
a transmitter configured to send a wireless signal representative of an audio signal from an audio source; and
a wireless loudspeaker comprising:
a housing defining an enclosure;
a receiver coupled to said housing, said receiver configured to receive said wireless signal representative of said audio signal;
an amplifier coupled to said housing and configured to amplify said audio signal;
at least one electromechanical transducer coupled to said housing and said amplifier and configured to generate sound waves; and
at least one electrical connector configured to electrically couple said wireless loudspeaker to an electrical source to provide electric power to said receiver and said amplifier, said at least one electrical connector further configured to mechanically couple and mount said wireless loudspeaker to said electrical source.

18. The system of claim 17, wherein said wireless loudspeaker further comprises at least one light source configured to at least partially illuminate a portion of said at least one electromechanical transducer.

19. The system of claim 17, wherein said wireless loudspeaker further comprises a transmitter configured to send a wireless signal representing at least one an audio signal.

20. The system of claim 17, wherein said at least one electrical connector comprises a removable connector configured to be removably coupled to said housing.

21. The system of claim 20, wherein removable connector is configured to be at least partially received within a cavity of said housing.

22. The system of claim 17, wherein said at least one electrical connector is configured to be coupled to a light socket.

23. The apparatus of claim 17, wherein said at least one electrical connector comprises a first and a least a second electrical terminal configured to be coupled to an electrical outlet.

24. A method comprising:
receiving, at a receiver of a wireless loudspeaker, a wireless signal representative of an audio signal from an audio source;
electrically and mechanically coupling said wireless loudspeaker to an electrical source using at least one electrical connector coupled to a housing of said wireless loudspeaker, wherein said at least one electrical connector is configured to provide power to said receiver and said amplifier and to mount said loudspeaker to said electrical source; and
generating sound waves using at least one electromechanical transducer coupled to said housing and said amplifier based on said audio signal.
